(19) United States
(12) Patent Application Publication
(10) Pub. No.: US 2007/0223489 A1
(43) Pub. Date: Sep. 27, 2007

(54) Method and portable device for DHCP address assignment

(76) Inventors: Paul W. Larson III, Round Rock, TX (US); Robert V. Williamson, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/388,852

(22) Filed: Mar. 24, 2006

(51) Int. Cl. H04L 12/28

(52) U.S. Cl. 370/395.5; 370/401

(57) ABSTRACT

A portable device for performing DHCP address assignment is disclosed. The portable device includes an exterior housing, a lanyard ring attached to the exterior housing and a network device processor mounted within the exterior housing for performing DHCP assignment to an external device. The device also includes a network cable penetrating through the exterior housing for connecting the network device processor to the external device. A keyboard for entering information mounted to the exterior housing and connected to the network device processor is provided, as is a display device for displaying information mounted to the exterior housing and connected to the network device processor.

### BACKGROUND OF THE INVENTION

1. Technical Field

The present invention relates in general to computer networks and in particular to addressing systems in computer networks. Still more particularly, the present invention relates to a system, method and computer program product for performing address assignment with a portable device.

2. Description of the Related Art

Dynamic Host Configuration Protocol (DHCP), which is currently implanted as DHCPv6, is a client-server networking protocol. A DHCP server provides configuration parameters specific to the DHCP client host requesting, generally, information required by the client host to participate on an IP network. DHCP also provides a mechanism for allocation of IP addresses to client hosts.

DHCP emerged as a standard protocol in October 1993. RFC 2131, which is incorporated herein by reference in its entirety, provides the latest (March 1997) DHCP definition. DHCP functionally became a successor to the older BOOTP protocol. Due to the backward-compatibility of DHCP, very few networks continue to use pure BOOTP.

The latest standard of the protocol, describing DHCPv6 (DHCP in a IPv6 environment), appeared in July 2003 as RFC 3315, which is incorporated herein by reference in its entirety. Depending on implementation, the DHCP server has three methods of allocating IP-addresses. First, through, manual allocation, a DHCP server performs the allocation based on a table with pairings of a MAC address and an IP address, which are manually filled by the server administrator. Only requesting clients with a MAC address listed in this table get the IP address according to the table. Second, in automatic allocation, a DHCP server permanently assigns to a requesting client a free IP-address from a range given by the administrator. Third, in dynamic allocation, which provides dynamic re-use of IP addresses, a network administrator assigns a range of IP addresses to DHCP, and each client computer on the LAN has its TCP/IP software configured to request an IP address from the DHCP server when that client computer's network interface card starts up. The request-and-grant process uses a lease concept with a controllable time period. This request and grant process eases the network installation procedure on the client computer side considerably and remains transparent to clients.

Some DHCP server implementations can update the DNS name associated with the client hosts to reflect the new IP address. They make use of the DNS update protocol established with RFC 2136.

There are occasions where a network or system administrator will want to quickly assign a specific DHCP address to a specific machine. Under the prior art, this manual assignment is usually accomplished by updating the DHCP server using the specified IP address in conjunction with the specific machine's MAC address. When the server receives an address request from the assigned machine (with matching NIC MAC address), the specified IP address will be provided to the assigned machine.

Unfortunately, situations exist in which the administrator does not know the MAC address of the assigned machine and has no way of easily retrieving it. Under the prior art, the usual solution to this problem requires a human to monitor the DHCP server logs when the assigned machine is attached and hope that the monitoring human will see the address given in the logs. This prior art solution is profoundly inadequate in large LAN/WAN environments. This solution wastes enormous time and energy.

### SUMMARY OF THE INVENTION

A portable device for performing DHCP address assignment is disclosed. The portable device includes an exterior housing, a lanyard ring attached to the exterior housing and a network device processor mounted within the exterior housing for performing DHCP assignment to an external device. The device also includes a network cable penetrating through the exterior housing for connecting the network device processor to the external device. A keyboard for entering information mounted to the exterior housing and connected to the network device processor is provided, as is a display device for displaying information mounted to the exterior housing and connected to the network device processor.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed descriptions of an illustrative embodiment when read in conjunction with the accompanying drawings, wherein:

FIG. 1A depicts a block diagram of a hardware-software stack of the components of a preferred embodiment of a portable system for DHCP address assignment in accordance with the present invention;

FIG. 1B depicts an exemplary embodiment of the physical user interface for a of a portable system for DHCP address assignment in accordance with a preferred embodiment of the present invention; and

FIG. 1C is a high-level logical flowchart of a process for performing DHCP address assignment using a portable device in accordance with a preferred embodiment of the present invention.

### DETAILED DESCRIPTION OF THE PREFERRED EMBODIMENT

The present invention provides a method, system, and computer program product for for performing address assignment with a portable device.

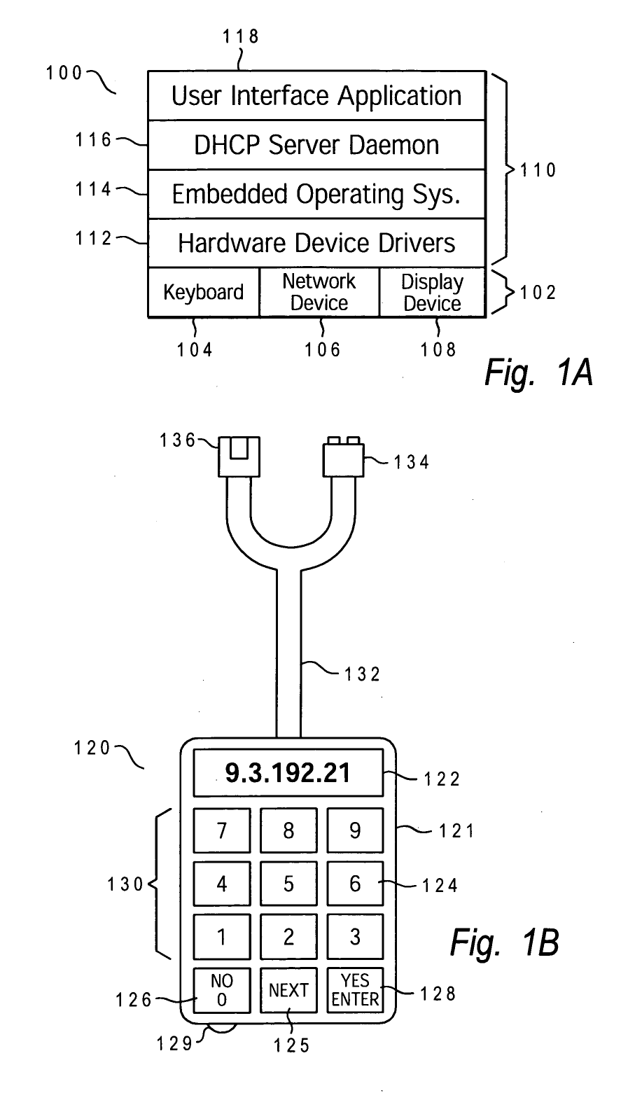

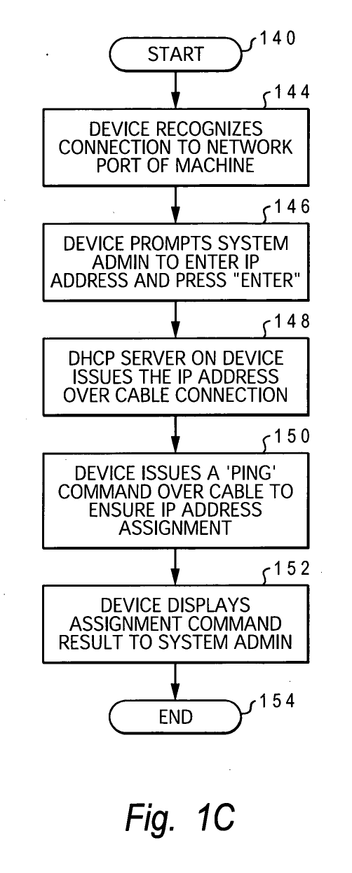

Turning now to the figures, and in particular to FIG. 1A, a block diagram of a hardware-software stack of the components of a preferred embodiment of a portable system for DHCP address assignment in accordance with the present invention is depicted. Portable device 100 contains a physical layer 102 composed of a keyboard 104, a network device 106 containing a dedicated processor and facility for attaching to a network, and a display device 108. A software stack 110 resides within network device 106 and includes hardware device drivers 112, an embedded operating system 114, a DHCP server daemon 116 for use with network device 106, and a user interface application 118 for controlling the keyboard 104 and the display device 108. Because portable device 100 is a special purpose device, no fixed disk storage and no pointer interface is included. Likewise, keyboard 104 does not contain alphabetical keys.

Referring now to FIG. 1B, an exemplary embodiment of the physical user interface for a of a portable system for DHCP address assignment in accordance with a preferred embodiment of the present invention is illustrated. Portable device 100 is embodied as a handheld device 120 with a metal exterior housing 121. A lanyard ring 129 extends from exterior housing 121 for the purpose of attaching portable device 100 to a keychain for transportation or a neck lanyard to prevent loss. An LED display 122, which is part of the display device 108 of FIG. 1A, protrudes through exterior housing 121 as does a button array 124, which is part of keyboard 104. Button array 124 contains nine number buttons 130 for entering numbers as well as a zero-no button 126 for entering a zero or a negative response to a prompt, an enter-yes button 128 for terminating input or making an affirmative response to a prompt, and a decimal-next button 125 for indicating a decimal point or a transition between fields of a prompt. Network cable 132 protrudes through exterior housing 121 and provides a connection to an external device for network device 106 across an ethernet plug 136 or a fibre channel plug 134.

Fibre Channel is a gigabit-speed network technology used primarily for Storage Networking. Fibre Channel is standardized by the T11 Technical Committee of the InterNational Committee for Information Technology Standards (INCITS), an American National Standard Institute (ANSI) accredited standards committee. Fibre Channel started for use primarily in the supercomputer field, but has become the standard connection type for storage area networks in enterprise storage. Despite its name, Fibre Channel signaling can run on both twisted-pair copper wire and fiber optic cables.

FIG. 1C is a high-level logical flowchart of a process for performing DHCP address assignment using a portable device in accordance with a preferred embodiment of the present invention. The process starts at step 140 and then proceeds to step 144, which illustrates portable device 100 recognizing a connection to a network port of an external device across network cable 132 and either ethernet plug 136 or a fibre channel plug 134. The process next moves to step 146. Step 146 illustrates portable device 100 prompting across LED display 122 for a user, such as a system administrator to enter an IP address using button array 124 and press enter-yes button 128. Once a user enters an IP address using button array 124 and presses enter-yes button 128, then the process moves to step 148, which depicts DHCP server daemon 116 on network device 106 performing DHCP assignment by issuing the IP address received in step 140 across network cable 132 and either ethernet plug 136 or fibre channel plug 134.

The process next proceeds to step 150, which illustrates network device 106 on portable device 100 issuing a ping across network cable 132 and either ethernet plug 136 or fibre channel plug 134. The process then moves to step 152, which illustrates network device 106 on portable device 100 displaying a result of the assignment performed in step 148 to the user. The process then ends at step 154.

While the invention has been particularly shown as described with reference to a preferred embodiment, it will be understood by those skilled in the art that various changes in form and detail may be made therein without departing from the spirit and scope of the invention. It is also important to note that although the present invention has been described in the context of a fully functional computer system, those skilled in the art will appreciate that the mechanisms of the present invention are capable of being distributed as a program product in a variety of forms, and that the present invention applies equally regardless of the particular type of signal bearing media utilized to actually carry out the distribution. Examples of signal bearing media include, without limitation, recordable type media such as floppy disks or CD ROMs and transmission type media such as analog or digital communication links.

What is claimed is:

1. A portable device for performing DHCP address assignment, said portable device comprising:
an exterior housing, wherein:
no fixed disk storage is attached to said portable device,
no alphabetical keypad is attached to said portable device, and
no pointer interface is attached to said portable device;
a lanyard ring attached to said exterior housing;
a network device processor mounted within said exterior housing for performing DHCP assignment to an external device;
a network cable penetrating through said exterior housing for connecting said network device processor to said external device;
a keyboard for entering information mounted to said exterior housing and connected to said network device processor; and
a display device for displaying information mounted to said exterior housing and connected to said network device processor.

2. The portable device of claim 1, wherein:
said lanyard ring attaches to a keychain for transportation.

3. The portable device of claim 1, wherein said lanyard ring attaches to a neck lanyard to prevent loss.

4. The portable device of claim 1, wherein said network cable is terminated with fibre channel plug.

5. The portable device of claim 1, wherein network cable is terminated with an ethernet plug.

6. The portable device of claim 1, wherein said network cable terminates in a pair of plugs comprising an ethernet plug and a fibre channel plug.

7. The portable device of claim 1, wherein said keyboard contains;
nine keys representing non-zero digits;
a zero key that can also be used to provide a negative response;
an enter key that can also be used to indicate a positive response; and
a decimal key that can also be used to indicate passing from one field to the next field of an entry.

8. A method for performing DHCP address assignment with a portable handheld device, said method comprising:
a network device processor on a portable handheld device recognizing a connection to a network port of an external device across a network cable;
a user interface application on said portable handheld device prompting through a display device a user to enter an IP address through a keypad for assignment to said external device;
said portable device receiving said IP address from said user through said keypad;
a DHCP server daemon within said network device processor performing DHCP assignment by issuing said IP address over said network cable connection to said external device; and
said user interface application on said portable handheld device displaying a result of said DHCP assignment through said display device.

9. The method of claim 8, wherein said step of a network device processor on a portable handheld device recognizing a connection to a network port of an external device across a network cable further comprises a network device processor on a portable handheld device recognizing a connection to a network port of an external device across a network cable terminated in a fibre channel plug.

10. The method of claim 8, wherein said step of a network device processor on a portable handheld device recognizing a connection to a network port of an external device across a network cable further comprises a network device processor on a portable handheld device recognizing a connection to a network port of an external device across a network cable terminated in an ethernet plug.

11. The method of claim 8, wherein said step of a DHCP server daemon within said network device processor performing DHCP assignment by issuing said IP address over said network cable connection to said external device further comprises said DHCP server daemon communicating with said network device processor across an embedded operating system within said network device processor.

12. The method of claim 8, wherein said step of a DHCP server daemon within said network device processor performing DHCP assignment by issuing said IP address over said network cable connection to said external device further comprises said DHCP server daemon communicating with said network device processor using hardware device drivers within said network device processor.

13. The method of claim 8, wherein step of said portable device receiving said IP address from said user through said keypad further comprises said portable device receiving said IP address from said user through said keypad using a user interface application within said network device processor.

14. The method of claim 8, wherein said method further comprises performing a ping operation over said network cable to discover said result of said DHCP assignment.

15. A machine-readable medium having a plurality of instructions processable by a machine embodied therein, wherein said plurality of instructions, when processed by said machine, causes said machine to perform a method, comprising:
a network device processor on a portable handheld device recognizing a connection to a network port of an external device across a network cable;
a user interface application on said portable handheld device prompting through a display device a user to enter an IP address through a keypad for assignment to said external device;
said portable device receiving said IP address from said user through said keypad;
a DHCP server daemon within said network device processor performing DHCP assignment by issuing said IP address over said network cable connection to said external device; and
said user interface application on said portable handheld device displaying a result of said DHCP assignment through said display device.

16. The machine-readable medium of claim 15, wherein said step of a network device processor on a portable handheld device recognizing a connection to a network port of an external device across a network cable further comprises a network device processor on a portable handheld device recognizing a connection to a network port of an external device across a network cable terminated in a fibre channel plug.

17. The machine-readable medium of claim 15, wherein said step of a network device processor on a portable handheld device recognizing a connection to a network port of an external device across a network cable further comprises a network device processor on a portable handheld device recognizing a connection to a network port of an external device across a network cable terminated in an ethernet plug.

18. The machine-readable medium of claim 15, wherein said step of a DHCP server daemon within said network device processor performing DHCP assignment by issuing said IP address over said network cable connection to said external device further comprises said DHCP server daemon communicating with said network device processor across an embedded operating system within said network device processor.

19. The machine-readable medium of claim 15, wherein said step of a DHCP server daemon within said network device processor performing DHCP assignment by issuing said IP address over said network cable connection to said external device further comprises said DHCP server daemon communicating with said network device processor using hardware device drivers within said network device processor.

20. The machine-readable medium of claim 15, wherein step of said portable device receiving said IP address from said user through said keypad further comprises said portable device receiving said IP address from said user through said keypad using a user interface application within said network device processor.
